(19) United States
(12) Patent Application Publication
(10) Pub. No.: US 2013/0256508 A1
(43) Pub. Date: Oct. 3, 2013

(54) PHOTOELECTRIC CONVERSION DEVICE

(71) Applicant: RENESAS ELECTRONICS CORPORATION, Kawasaki-shi (JP)

(72) Inventors: Tadashi JAHANA, Kanagawa (JP); Hiroyuki Sawano, Kanagawa (JP); Seiji Kawata, Kanagawa (JP); Masahiro Fujii, Kanagawa (JP); Junichi Nakamura, Kanagawa (JP)

(73) Assignee: RENESAS ELECTRONICS CORPORATION, Kawasaki-shi (JP)

(21) Appl. No.: 13/752,236

(22) Filed: Jan. 28, 2013

(30) Foreign Application Priority Data
Mar. 28, 2012 (JP) 2012-074652

(51) Int. Cl. G01J 1/44

(52) U.S. Cl. CPC G01J 1/44
USPC 250/206

(57) ABSTRACT

A photoelectric conversion device is provided that has high linearity of output current to illuminance and is applicable to illumination sensors. The photoelectric conversion device outputs appropriate current by complementing first current, which is generated in response to incident light, with complementary current. The complementary current is generated based on second current flowing in response to the light. The second current is generated by a device having the same element area as that of a device that generates the first current. When the second current flows, the complementary current is generated based on a direction of the second current and is then added to the first current.

### CROSS-REFERENCE TO RELATED APPLICATIONS

The disclosure of Japanese Patent Application No. 2012-074652 filed on Mar. 28, 2012 including the specification, drawings and abstract is incorporated herein by reference in its entirety.

### BACKGROUND

The present invention relates to a photoelectric conversion device, and, for example, to a photoelectric conversion device applicable to a high-precision illumination sensor.

In recent years, mobile devices, such as cellular phones and smartphones, which employ a flat-panel display with backlighting, have been in high-volume production. Many of the mobile devices are provided with a function of adjusting the backlight in response to the brightness of ambient light for the purpose of power consumption reduction and battery life extension. To achieve the light-amount adjustment function, an illumination sensor that measures the amount of ambient light of the mobile devices is built in many mobile devices.

The measurement of illuminance by the illumination sensor is required to be done at the same sensitivity level as the human eye (spectral sensitivity). However, the illumination sensors use photodiodes that are often sensitive to light out of a wavelength range of visible light (light with a wavelength from approximately 400 to 800 nm). Some techniques are known to correct sensor output for the light out of the visible wavelength range (e.g., see Japanese Unexamined Patent Publication Nos. 2009-238944 and 2009-158928).

Japanese Unexamined Patent Publication No. 2009-238944 discloses a technique of imparting sensitivity close to the spectral sensitivity of the human eye to an illumination sensor, which includes a plurality of photodiodes each having peak sensitivity of different wavelengths, through a current subtraction/correction process in which the current generated from light out of the visible wavelength range is amplified and attenuated. Referring to Japanese Unexamined Patent Publication No. 2009-238944, a photodiode having peak sensitivity in a visible wavelength range and a photodiode having peak sensitivity out of the visible wavelength range are prepared, and the output currents from the two photodiodes are multiplied by a coefficient via a multiplier. After subtracting the current value derived from the light out of the visible wavelength range from the current value derived from the visible light by a subtracter, a limiter circuit outputs only positive current values from the subtraction results, and a signal amplifier amplifies the output current to obtain current corresponding to visible light intensity.

General illumination sensors are built in display devices of cellular phones, smartphones or some other mobile devices and measure illuminance of light having passed through the display panels. Many display panels are infrared-transmissive so as to receive infrared light signals used in infrared communications and remote controllers, but do not easily allow visible light to pass therethrough to make the inside of the panels invisible in consideration of appearance.

If such an illumination sensor receives light including strong infrared light components, like light from an incandescent lamp, through the display panel, a large amount of current is generated in the photodiodes with peak sensitivity out of the visible wavelength range. The large amount of current is to be subtracted from current from photodiodes with peak sensitivity in a visible wavelength range. As a result, the limiter outputs an extremely small amount of current, and therefore the illumination sensor sometimes cannot achieve true illuminance, which should be obtained in the actual range of spectral sensitivity. It is now required to provide illumination sensors capable of obtaining appropriate output even under environments with a lot of infrared light components.

Japanese Unexamined Patent Publication No. 2009-158928 discloses an illumination sensor capable of maintaining high linearity of output signals in a wide illuminance range. Japanese Unexamined Patent Publication No. 2009-158928 presents a case where a halogen lamp is used as a light source to make an environment with a lot of infrared light components. Generally, halogen lamps emit light including a lot of infrared light components. The illumination sensor of Japanese Unexamined Patent Publication No. 2009-158928 has a first light-receiving unit. In the first light-receiving unit, the difference obtained by subtracting an infrared light component from a visible light component is a negative value, resulting in differential current of zero. The illumination sensor of Japanese Unexamined Patent Publication No. 2009-158928 further includes a second light-receiving unit and a third light-receiving unit whose subtraction ratios of the infrared light component are set lower than that of the first light-receiving unit. Therefore, the differential calculations at the second and third light-receiving units do not result in negative values, and the second and third light-receiving units output differential current of some value.

In addition, Japanese Unexamined Patent Publication No. 2009-158928 discloses the operation of the illumination sensor when an incandescent lamp is used as a light source. The incandescent lamp emits more infrared radiation than the halogen lamp does. When using the incandescent lamp, the differential current at the second light-receiving unit of the illumination sensor of Japanese Unexamined Patent Publication No. 2009-158928 becomes also zero; however, the differential current at the third light-receiving unit whose subtraction ratio of the infrared light component is the lowest does not exhibit a negative value; therefore, the third light-receiving unit outputs differential current of some value.

Furthermore, Japanese Unexamined Patent Publication No. 2009-158928 also discloses the operation of the illumination sensor when a fluorescent lamp or a white LED, which emits less infrared light radiation, is used as a light source. In this case, the differential current at the first to third light-receiving units results in positive values; therefore, all the light-receiving units output differential current of some value.

The illumination sensor of Japanese Unexamined Patent Publication No. 2009-158928 is configured to be applicable to environments with a lot of infrared light components. In addition, all the visible-light photodiodes, whose areas are relatively large, of the illumination sensor are coupled with amplifiers. Photodiodes have leakage current (generally referred to as “dark current”) flowing therethrough irrespective of light emitted thereon. The leakage current may sometimes deteriorate the linearity of output current in relation to illuminance. For example, if leakage current occurs in the illumination sensor of Japanese Unexamined Patent Publication No. 2009-158928, leakage current from all of the visible-light photodiodes is fed to the amplifiers. Therefore, if leakage current caused by ambient temperature occurs in the photodiodes, the leakage current sometimes flows to an output of the illumination sensor even in a dark environment.

### SUMMARY

In view of the aforementioned problems, there is a demand for illumination sensors that can produce an appropriate output even in an environment with a lot of infrared light components and can achieve high output current linearity in relation to illuminance even in an environment where leakage current flows. The other problems and novel features will more fully appear from the following detailed description and the accompanying drawings of the invention.

The appropriate output can be produced by complementing first current, which is generated in response to light emitted, with complementary current. The complementary current is generated based on second current that flows in response to the light. The second current is generated by a device having the same element area as that of a device in which the first current is generated. When the second current flows, the complementary current is generated based on the direction in which the second current flows and is then added to the first current.

With brief description about the effects obtained from typical techniques disclosed in the present application, it will be apparent that the present invention can provide an illumination sensor with high linearity of output current in relation to illuminance.

### BRIEF DESCRIPTION OF THE DRAWINGS

FIG. 1A is a circuit diagram illustrating an exemplary configuration of a photoelectric conversion device 1 according to a first embodiment;

FIG. 1B is a plan view illustrating an exemplary configuration of a first photoelectric conversion block 2 and a second photoelectric conversion block 6 of the photoelectric conversion device 1 according to the first embodiment;

FIG. 1C is a plan view of an exemplary configuration of the photoelectric conversion device 1;

FIG. 2 is a circuit diagram illustrating exemplary operation of the photoelectric conversion device 1 according to the first embodiment;

FIG. 3 is a circuit diagram illustrating another exemplary operation of the photoelectric conversion device 1 according to the first embodiment;

FIG. 4 is a circuit diagram illustrating an exemplary configuration of a photoelectric conversion device 1 according to a second embodiment;

FIG. 5 is a circuit diagram illustrating an exemplary configuration of a photoelectric conversion device 1 according to a third embodiment;

FIG. 6 is a circuit diagram illustrating exemplary operation of the photoelectric conversion device 1 when illuminated with light mainly in visible wavelengths;

FIG. 7 is a circuit diagram illustrating exemplary operation of the photoelectric conversion device 1 when illuminated with light including a mixture of visible light and infrared light;

FIG. 8 is a circuit diagram illustrating exemplary operation of the photoelectric conversion device 1 when receiving light including a high proportion of infrared light from a light source, such as an incandescent lamp;

FIG. 9 is a circuit diagram illustrating an exemplary configuration of a photoelectric conversion device 1 according to a fourth embodiment;

FIG. 10 is a plan view illustrating an exemplary configuration of a first photoelectric conversion block 2 and a second photoelectric conversion block 6 according to the fourth embodiment;

FIG. 11 is a circuit diagram illustrating exemplary operation of the photoelectric conversion device 1 according to the fourth embodiment;

FIG. 12 is a circuit diagram illustrating another exemplary operation of the photoelectric conversion device 1 according to the fourth embodiment;

FIG. 13 is a graph showing output current when a first control switch 61 to an eighth control switch 68 are switched ON;

FIG. 14 is a graph showing output current when the first control switch 61 to eighth control switch 68 are switched OFF;

FIG. 15 is a circuit diagram illustrating an exemplary configuration of a photoelectric conversion device 1 according to a fifth embodiment;

FIG. 16 is a graph showing output current of the photoelectric conversion device 1 according to the fifth embodiment;

FIG. 17 is a graph showing output current of the photoelectric conversion device 1 according to the fifth embodiment;

FIG. 18 is a circuit diagram illustrating an exemplary configuration of a photoelectric conversion device 1 according to a sixth embodiment; and

FIG. 19 is a circuit diagram illustrating an exemplary configuration of a photoelectric conversion device 1 according to a seventh embodiment.

### DETAILED DESCRIPTION

### First Embodiment

With reference to the drawings, embodiments of the present application will be described below. Through the drawings used to describe the embodiments, like components are denoted by like numerals in principle and will not be further explained.

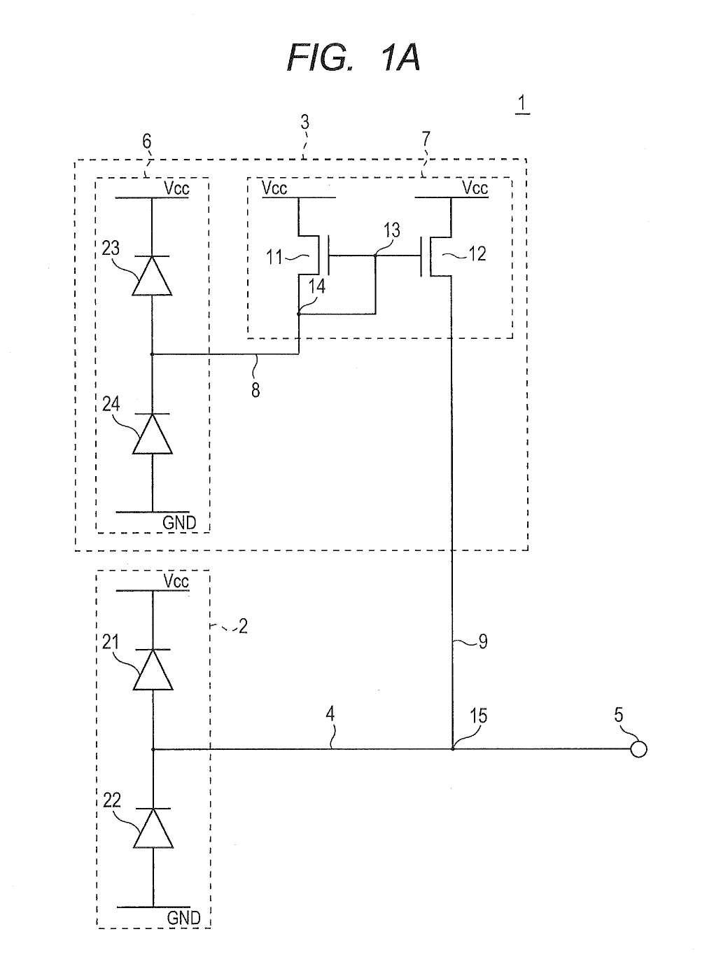

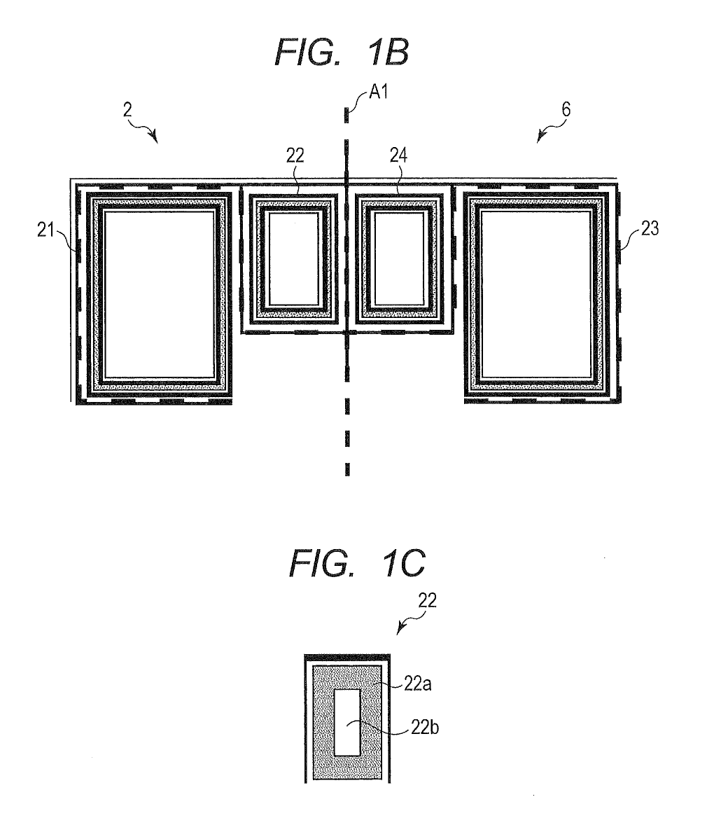

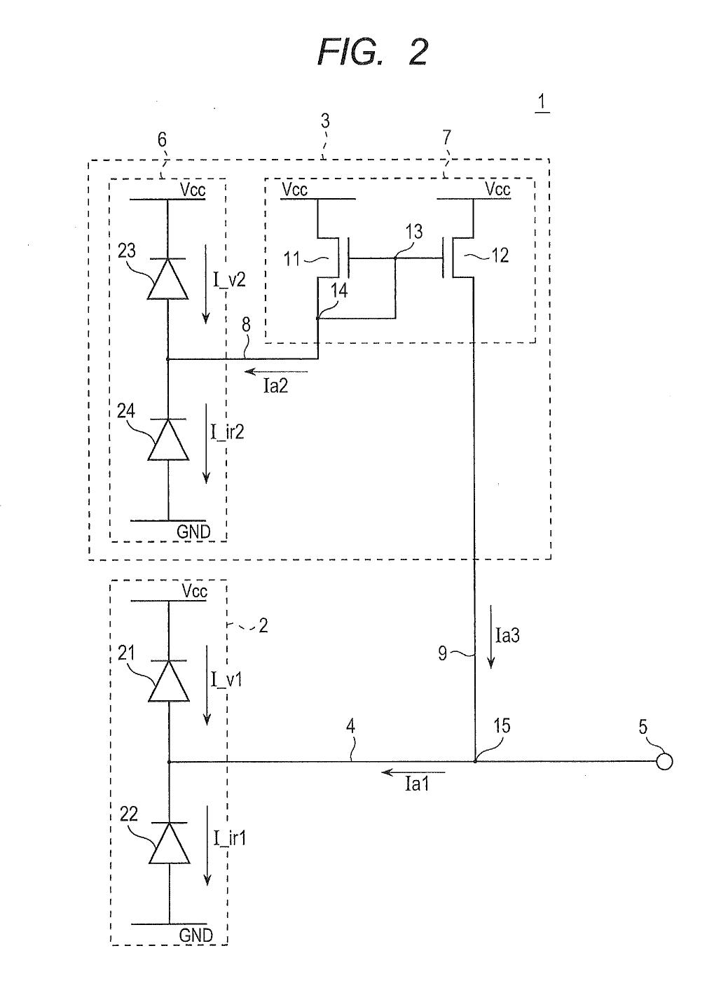

FIG. 1A is a circuit diagram illustrating the configuration of a photoelectric conversion device 1 according to the first embodiment. The photoelectric conversion device 1 of the first embodiment is applicable to a high-precision illumination sensor. The photoelectric conversion device 1 includes a first photoelectric conversion block 2 and a complementary current supply block 3. The first photoelectric conversion block 2 is coupled with an output node 5 via a first wire 4. The complementary current supply block 3 is coupled with the output node 5 via a complementary current supply wire 9. The output node 5 is coupled with an amplifier (not shown) in the latter stage. The first wire 4 and the complementary current supply wire 9 are coupled with each other via a coupling node 15.

The first photoelectric conversion block 2 generates current corresponding to incident light. The first photoelectric conversion block 2 includes a first visible-light photodiode 21 and a first infrared-light photodiode 22. The first visible-light photodiode 21 has peak sensitivity in a visible wavelength range. More specifically, the peak sensitivity is approximately 600 nm. The first infrared-light photodiode 22 has peak sensitivity at a different wavelength from the first visible-light photodiode 21. The first embodiment shows, as an example, the first infrared-light photodiode 22 has peak sensitivity around wavelengths of infrared radiation (infrared light), more specifically, at around a wavelength of 900 nm in order to provide an easy understanding of the technique of the present invention. Photocurrent, which is a difference between current flowing with carriers produced by the first visible-light photodiode 21 and current flowing with carriers produced by the first infrared-light photodiode 22, flows through the first wire 4. As shown in FIG. 1A, the complementary current supply block 3 includes a second photoelectric conversion block 6, a complementary current generation circuit (current mirror) 7, and a second wire 8. The second photoelectric conversion block 6 generates current corresponding to incident light. The second photoelectric conversion block 6 includes a second visible-light photodiode 23 and a second infrared-light photodiode 24. The second visible-light photodiode 23 has peak sensitivity in a visible wavelength range.

More specifically, the peak sensitivity is approximately 600 nm. The second infrared-light photodiode 24 has peak sensitivity at a wavelength different from the second visible-light photodiode 23. An example described below shows the second infrared-light photodiode 24 having peak sensitivity in a wavelength range of infrared radiation (infrared light), more specifically, at a wavelength of approximately 900 nm.

Photocurrent, which is a difference between current flowing with carriers produced by the second visible-light photodiode 23 and current flowing with carriers produced by the second infrared-light photodiode 24, flows through the second wire 8.

When the current flowing through the second wire 8 is regarded as reference current, the complementary current generation circuit 7 generates output current corresponding to the reference current. The generated output current is fed to the coupling node 15 via the complementary current supply wire 9.

The embodiment below introduces an example in which the complementary current generation circuit 7 is a current mirror including a current mirror's first transistor 11 and a current mirror's second transistor 12. The complementary current generation circuit 7 supplies current to be drawn out from the complementary current supply block 3 to the coupling node 15 through the complementary current supply wire 9 in response to the current flowing into the second photoelectric conversion block 6.

As shown in FIG. 1A, the current mirror's first and second transistors 11, 12 have gates commonly coupled with each other via a common gate coupling node 13. The drain of the first transistor 11 is shorted to the common gate coupling node 13 with a coupling node 14. The first transistor 11 is coupled with the second wire 8 via the coupling node 14. The drain of the second transistor 12 is coupled with the complementary current supply wire 9.

FIG. 1B is a plan view illustrating an exemplary configuration of the first photoelectric conversion block 2 and the second photoelectric conversion block 6 of the photoelectric conversion device 1 according to the first embodiment. As illustrated in FIG. 1B, the first photoelectric conversion block 2 and the second photoelectric conversion block 6 are symmetrically arranged with respect to axis A1. In addition, the first photoelectric conversion block 2 and the second photoelectric conversion block 6 are arranged in the same layout. Specifically, the first visible-light photodiode 21 and the second visible-light photodiode 23 have the same element area, while the first infrared-light photodiode 22 and the second infrared-light photodiode 24 have the same element area.

As mentioned above, the first photoelectric conversion block 2 is designed to have the same area as that of the second photoelectric conversion block 6. This means that the difference in leakage current between the first visible-light photodiode 21 and the first infrared-light photodiode 22 is equal to the difference in leakage current between the second visible-light photodiode 23 and the second infrared-light photodiode 24. Even when the temperature around the photoelectric conversion device 1 or the temperature of the photoelectric conversion device 1 itself is high, the photoelectric conversion device 1 configured as above can obtain current output without being influenced by temperature.

FIG. 1C is a plan view illustrating an exemplary configuration of the photoelectric conversion device 1. In the photoelectric conversion device 1 according to the first embodiment, a light-shielding structure with an opening is used to cover the first photoelectric conversion block 2 and second photoelectric conversion block 6 in order to adjust the area for receiving light. In other words, a window of each photodiode is partially blocked from light by an AL layer or a layer of other materials to adjust the light-receiving area, thereby changing sensitivity of the photodiodes.

A description will be made about adjustment of the light-receiving area of the first infrared-light photodiode 22 for the purpose of providing an easy understanding of the technique of the present invention. As shown in FIG. 1C, the upper part of the first infrared-light photodiode 22 is covered with a light-shielding structure (AL layer) 22a having an opening 22b, and light having passed through the opening 22b impinges the surface of the first infrared-light photodiode 22. Appropriately setting the size of the opening 22b at a design stage can adjust the amount of light applied onto the first infrared-light photodiode 22.

In the photoelectric conversion device 1 of the first embodiment, when the ratio between the light-receiving area of the visible-light photodiode and the light-receiving area of the infrared-light photodiode is expressed by light-receiving area of visible-light photodiode: light-receiving area of infrared-light photodiode, the ratio value can be obtained by the light-receiving area of the visible-light photodiode/the light-receiving area of the infrared-light photodiode. The photoelectric conversion device 1 of the first embodiment is configured such that the ratio value of the first photoelectric conversion block 2>the ratio value of the second photoelectric conversion block 6. In this description, the light-receiving area of the first visible-light photodiode 21 is referred to as a first visible PD area. The light-receiving area of the first infrared-light photodiode 22 is referred to as a first infrared PD area. The light-receiving area of the second visible-light photodiode 23 is referred to as a second visible PD area. The light-receiving area of the second infrared-light photodiode 24 is referred to as a second infrared PD area. The photoelectric conversion device 1 is configured so as to establish the following inequality: first visible PD area/first infrared PD area>second visible PD area/second infrared PD area.

According to the photoelectric conversion device 1 as configured above, the complementary current supply block 3 can easily output negative current (current as if it flows to the second photoelectric conversion block 6) with a light source that emits a lot of infrared radiation, such as an incandescent lamp. The infrared component from the light source is converted into current to flow to the second wire 8, and the complementary current generation circuit 7 adds mirror current, which is generated by the action of the current mirror, to current in the first wire 4.

FIG. 2 is a circuit diagram illustrating exemplary operation of the photoelectric conversion device 1 according to the first embodiment. FIG. 2 illustrates by example the operation of the photoelectric conversion device 1 that is irradiated with light including a lot of infrared light. In the embodiment, first current Ia1 generated in the first photoelectric conversion block 2 and flowing through the first wire 4 is expressed by: first current Ia1=first visible light PD current I_v1−first infrared light PD current I_ir1. Second current Ia2 generated in the second photoelectric conversion block 6 and flowing through the second wire 8 is expressed by: second current Ia2=second visible light PD current I_v2−second infrared light PD current I_ir2. The light-receiving areas of the second visible-light photodiode 23 and the second infrared-light photodiode 24 in the second photoelectric conversion block 6 are set so as to establish an inequality: second visible light PD current I_v2<second infrared light PD current I_ir2, when the photoelectric conversion device 1 of the first embodiment is irradiated with light including a lot of infrared light and the first current Ia1 of the first photoelectric conversion block 2 is zero.

Because the light includes a lot of infrared light, the second current Ia2 (second visible light PD current I_v2−second infrared light PD current I_ir2) flowing through the second wire 8 changes its direction so as to be drawn into the second photoelectric conversion block 6 in the complementary current supply block 3. The second current Ia2 is folded in the complementary current generation circuit 7 (1:1 current mirror) to be output as complementary current Ia3. The complementary current Ia3 is expressed by: complementary current Ia3=second infrared light PD current I_ir2−second visible light PD current Iv2. The complementary current Ia3 is added to the first current Ia1 coming from the first photoelectric conversion block 2.

Additionally, the light-receiving areas of the photodiodes in the photoelectric conversion device 1 of the first embodiment are set so as to establish an inequality: |first visible light PD current I_v1−first infrared light PD current I_ir1|<(second visible light PD current I_v2−second infrared light PD current I_ir2|, in other words, complementary current Ia3>first current Ia1. Accordingly, even if the output of the first photoelectric conversion block 2 is negative current (in a direction that the first current Ia1 flowing through the first wire 4 is drawn toward the first photoelectric conversion block 2), the current output is always positive.

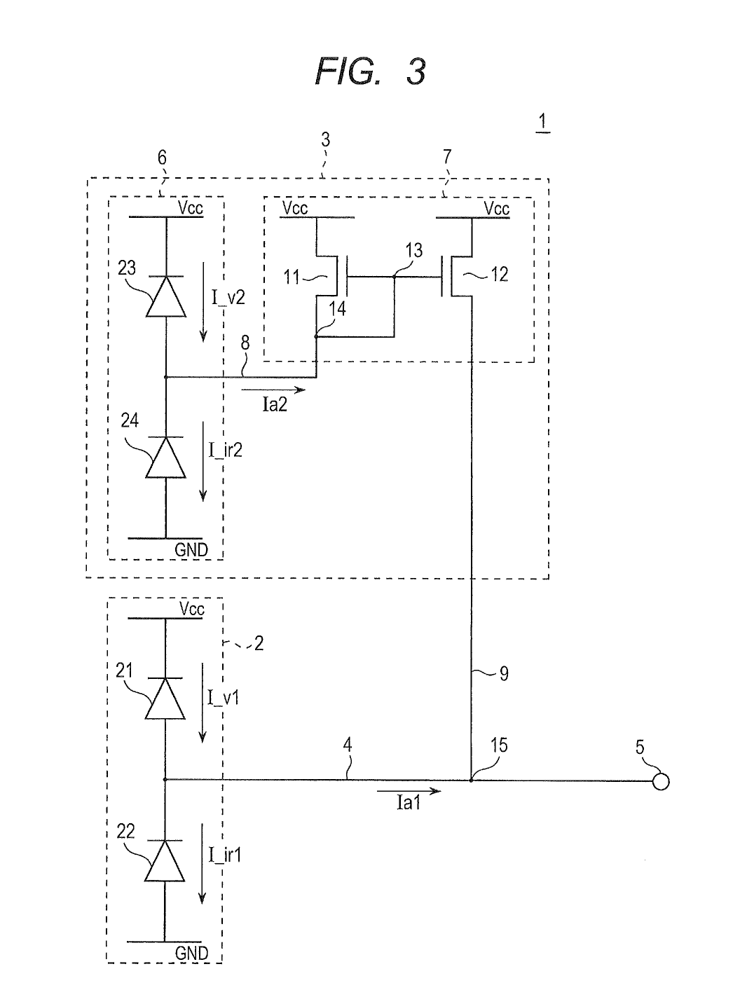

FIG. 3 is a circuit diagram illustrating another exemplary operation of the photoelectric conversion device 1 according to the first embodiment. FIG. 3 illustrates the operation of the photoelectric conversion device 1 that is irradiated with light including a lot of visible light. When light including a lot of visible light is emitted from a light source, such as a fluorescent lamp, the second photoelectric conversion block 6 generates second visible light PD current I_v2>second infrared light PD current I_ir2 because the light includes a lot of visible light. Then, second current Ia2 from the second photoelectric conversion block 6 flows through the second wire 8 in a positive direction (in which current is drawn out from the second photoelectric conversion block 6 to the complementary current generation circuit 7). The complementary current generation circuit 7, which is a PMOS current mirror, does not generate output current and therefore its output is zero. Then, only current from the first photoelectric conversion block 2 is output from the output node 5, in other words, only (first visible light PD current I_v1−first infrared light PD current I_ir1)=first current Ia1 is output from the output node 5. The photoelectric conversion device 1 of the first embodiment that is configured as described above can output a certain amount of current in relation to a certain illuminance irrespective of the types of light source.

In the above-described illumination sensor of Japanese Unexamined Patent Publication No. 2009-158928, all of the visible-light photodiodes having a relatively large area are coupled with amplifiers. Therefore, once leakage current occurs, the current leaked from all the visible-light photodiodes goes to the amplifiers. Under this circumstance, if the photodiode leakage caused by ambient temperature occurs, some amounts of current flows to the output of the illumination sensor even in a dark environment.

In the photoelectric conversion device 1 according to the first embodiment, the area (element area) of the first photoelectric conversion block 2 and the area (element area) of the second photoelectric conversion block 6 are designed to be identical. This design makes the leakage current of the first photoelectric conversion block 2 and the leakage current of the second photoelectric conversion block 6 the same. Therefore, setting the areas of the first visible-light photodiode 21, first infrared-light photodiode 22, second visible-light photodiode 23, and second infrared-light photodiode 24 so as to establish an inequality, i.e., leakage current of visible-light photodiode<leakage current of infrared-light photodiode, results in complementary current Ia3=−first current Ia1. Hence, even if the leakage current of the photodiodes increases with high temperatures, the leakage current is compensated for, thereby obtaining correct photocurrent irrespective of temperature variations.

### Second Embodiment

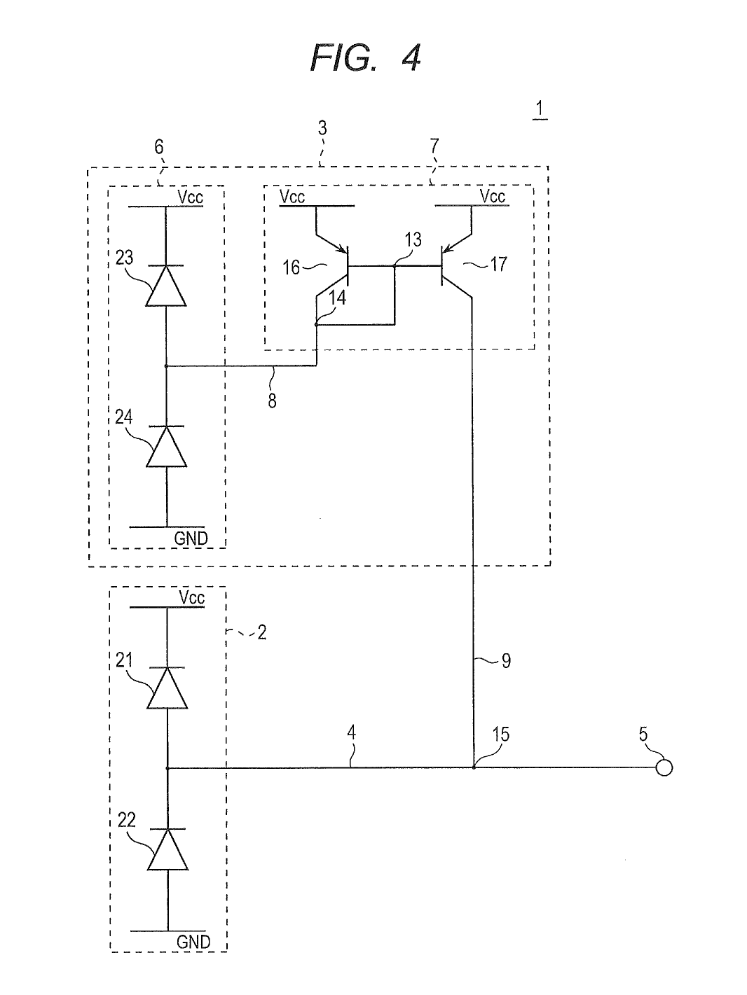

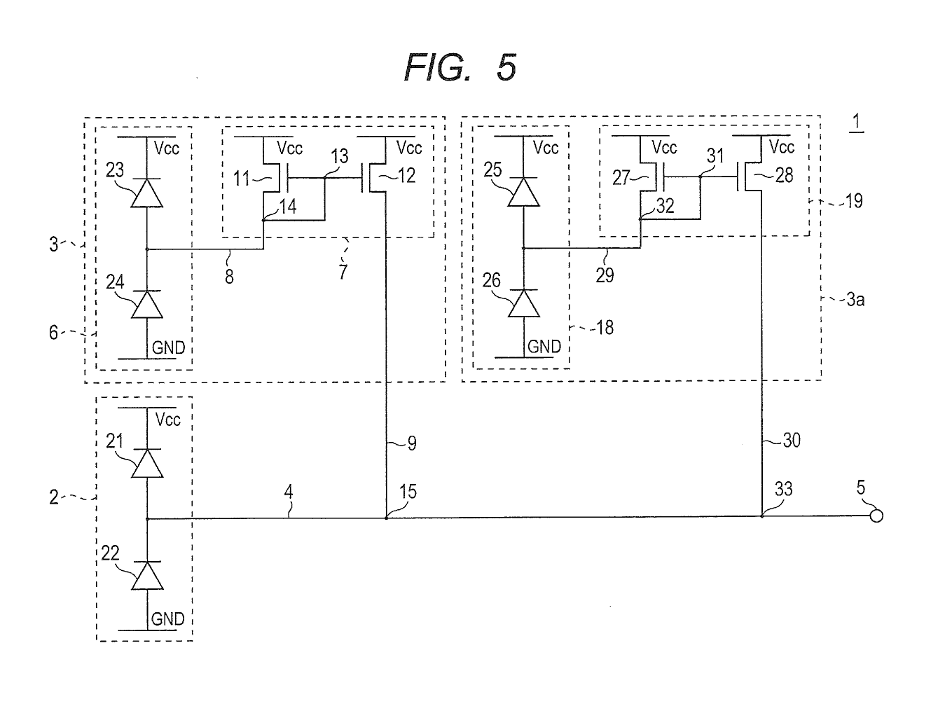

The following is a description about the second embodiment of the present invention. FIG. 4 is a circuit diagram illustrating an exemplary configuration of a photoelectric conversion device 1 according to the second embodiment. The photoelectric conversion device 1 of the second embodiment includes a current mirror having a first PNP bipolar transistor 16 and a second PNP bipolar transistor 17. As illustrated in FIG. 4, the current mirror circuit with the first PNP bipolar transistor 16 and second PNP bipolar transistor 17 in the photoelectric conversion device 1 is implemented by a BiCMOS process. Thus implemented current mirror circuit provided in the complementary current generation circuit 7 can reduce output variations.

### Third Embodiment

The following is a description of the third embodiment of the present invention. FIG. 5 is a circuit diagram illustrating an exemplary configuration of a photoelectric conversion device 1 according to the third embodiment. The photoelectric conversion device 1 of the third embodiment has the same configuration as the photoelectric conversion device 1 of the first embodiment, but further includes a complementary current supply block 3a. Referring to FIG. 5, the complementary current supply block 3a provided in the photoelectric conversion device 1 of the third embodiment includes a third photoelectric conversion block 18 and a complementary current generation circuit (current mirror) 19. The third photoelectric conversion block 18 includes a third visible-light photodiode 25 and a third infrared-light photodiode 26.

Like the first visible-light photodiode 21 and second visible-light photodiode 23, the third visible-light photodiode 25 has peak sensitivity in a visible wavelength range. More specifically, the peak sensitivity is approximately 600 nm. The third infrared-light photodiode 26 has peak sensitivity in a wavelength range of infrared radiation (infrared light), more specifically, at a wavelength of approximately 900 nm.

The complementary current generation circuit 19 is a current mirror circuit that functions the same as the complementary current generation circuit 7. As shown in FIG. 5, a current mirror's first transistor 27 and a current mirror's second transistor 28 are commonly coupled with each other via a common gate coupling node 31. The drain of the first transistor 27 is shorted to the common gate coupling node 31 with a coupling node 32. The first transistor 27 is also coupled with a third wire 29 via a coupling node 32. The drain of the second transistor 28 is coupled with a complementary current supply wire 30.

When the current flowing through the third wire 29 is regarded as reference current, the complementary current generation circuit 19 generates output current corresponding to the reference current. The generated output current is fed to a coupling node 33 via the complementary current supply wire 30. In other words, the complementary current generation circuit 19 supplies current so as to be drawn out from the complementary current supply block 3a to the coupling node 33 through the complementary current supply wire 30 in response to the current flowing into the third photoelectric conversion block 18.

The first photoelectric conversion block 2 generates current (photocurrent) with carriers produced by applying light onto the first visible-light photodiode 21 and carriers produced by applying light onto the first infrared-light photodiode 22. Likewise, the second photoelectric conversion block 6 generates current (photocurrent) with carriers produced by applying light onto the second visible-light photodiode 23 and carriers produced by applying light onto the second infrared-light photodiode 24. The third photoelectric conversion block 18 generates current (photocurrent) with carriers produced by applying light onto the third visible-light photodiode 25 and carriers produced by applying light onto the third infrared-light photodiode 26.

The photoelectric conversion device 1 of the third embodiment generates photocurrent from ambient light. As with the case of the photoelectric conversion device 1 of the first embodiment, the photoelectric conversion device 1 of the third embodiment is provided with a light-shielding structure, such as an AL layer, on the upper part of windows of the respective photodiodes. The light-shielding structure partially has an opening and is used to selectively block light in order to change the sensitivity of the photodiodes.

Specifically, when the ratio between the light-receiving area of the visible-light photodiode and the light-receiving area of the infrared-light photodiode is expressed by light-receiving area of visible-light photodiode light-receiving area of infrared-light photodiode, the ratio value can be obtained by the light-receiving area of the visible-light photodiode/light-receiving area of the infrared-light photodiode. The photoelectric conversion device 1 of the third embodiment is configured such that the ratio values of the respective blocks establish an inequality: first photoelectric conversion block 2>second photoelectric conversion block 6>third photoelectric conversion block 18. In other words, the photoelectric conversion device 1 is configured so as to establish an inequality: first visible light PD area/first infrared light PD area>second visible light PD area/second infrared light PD area>third visible light PD area/third infrared light PD area.

In the second photoelectric conversion block 6, the value of the light-receiving area of the visible-light photodiode —light-receiving area of the infrared-light photodiode is determined so that the complementary current generation circuit 7 can output current in response to light including a certain amount of infrared light (infrared radiation) from a light source (e.g., sunlight). In the third photoelectric conversion block 18, the value of the light-receiving area of the visible-light photodiode/the light-receiving area of the infrared-light photodiode is determined so that the complementary current generation circuit 19 can output current in response to light including a large amount of infrared from a light source (e.g., a black-body radiation source at a color temperature of less than 2800 K).

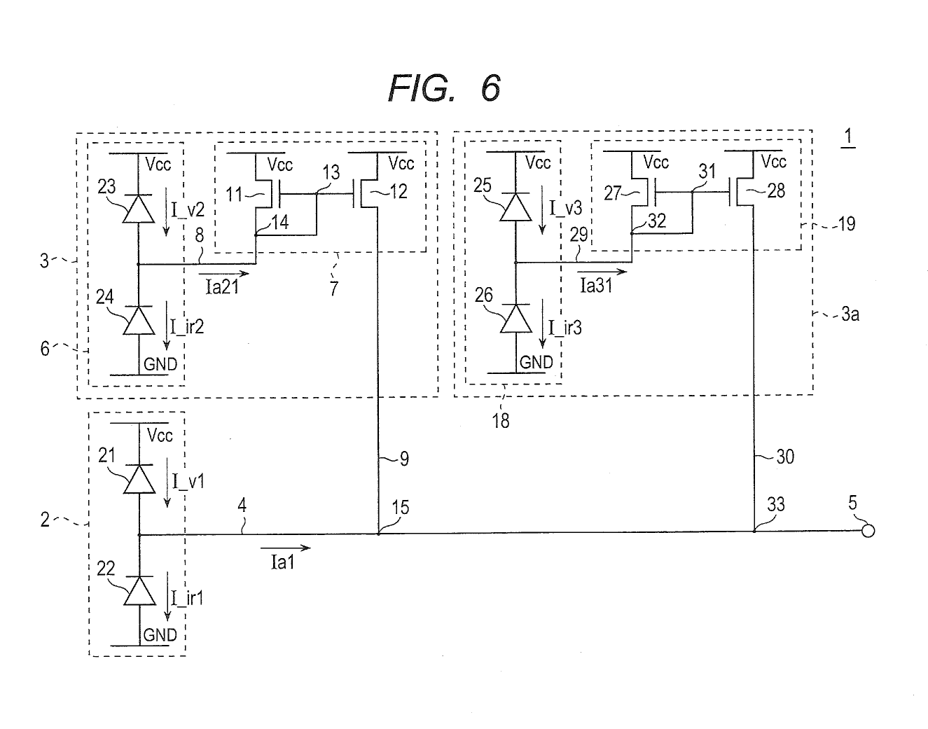

FIG. 6 is a circuit diagram illustrating exemplary operation of the photoelectric conversion device 1 when a light source emits light mainly in a visible wavelength range. When receiving light from a light source, such as a fluorescent lamp, emitting mostly visible light, the second visible-light photodiode 23 generates second visible light PD current I_v2, while the second infrared-light photodiode 24 generates second infrared light PD current I_ir2. Naturally, the current (second infrared light PD current I_ir2) generated by the second infrared-light photodiode 24, which responds to mainly infrared light, is smaller than the current (second visible light PD current I_v2) generated by the second visible-light photodiode 23, which responds to mainly visible light.

Thus, the second current Ia21 is generated so as to be drawn into the coupling node 14 of the complementary current generation circuit 7. In other words, the second current Ia21 is generated so as to be drawn into the current mirror composed of the first and second transistors 11, 12. The current mirror in the complementary current generation circuit 7 does not generate mirror current from the current to be drawn thereto. Therefore, the second transistor 12 does not output current (complementary current Ia3). In addition, in the third photoelectric conversion block 18, the third visible-light photodiode 25 generates third visible light PD current I_v3, while the third infrared-light photodiode 26 generates third infrared-light PD current I_ir3.

The current (third infrared light PD current I_ir3) generated by the third infrared-light photodiode 26, which responds mainly to infrared light, is smaller than the current (third visible light PD current I_v3) generated by the third visible-light photodiode 25, which responds mainly to visible light. Thus, the third current Ia31 is generated so as to be drawn into the coupling node 32. In other words, the third current Ia31 is generated so as to be drawn into the current mirror having the first and second transistors 27, 28. The current mirror of the complementary current generation circuit 19 does not generate mirror current from the current to be drawn thereto. Therefore, the second transistor 28 does not output current. When the light source emits light mainly in a visible wavelength range, only the current (first current Ia1) from the first photoelectric conversion block 2 is output from the output node 5.

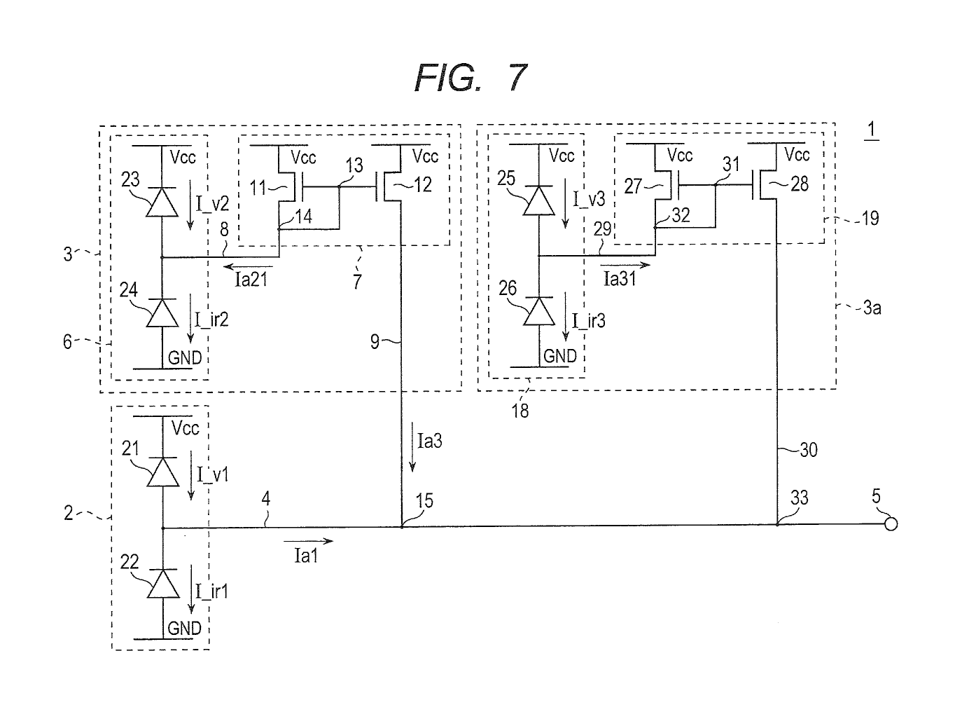

FIG. 7 is a circuit diagram illustrating exemplary operation of the photoelectric conversion device 1 when a light source, such as the sun, emits light including a mixture of visible light and infrared light. In comparison with light given off by a light source like a fluorescent lamp, light from a black-body radiation source, such as the sun, includes a lot of infrared light. In this embodiment, the third visible-light photodiode 25 and the third infrared-light photodiode 26 in the third photoelectric conversion block 18 are configured so as to establish an inequality when illuminated with black-body radiation at a color temperature of 2800 K or higher: third visible light PD current I_v3>third infrared-light PD current I_ir3.

With light given off by the black-body radiation source, i.e., the sun, the first visible-light photodiode 21 generates first visible light PD current I_v1, and the first infrared-light photodiode 22 generates first infrared light PD current I_ir1. The first photoelectric conversion block 2 generates first current Ia1 based on the difference between the first visible light PD current I_v1 and the first infrared, light PD current I_ir1. The amount of the first current Ia1 to be output is relatively smaller than the first current Ia1 obtained from the light mainly in a visible wavelength range.

When receiving light from the light source that emits light including a mixture of visible light and infrared light, the second visible-light photodiode 23 generates second visible light PD current I_v2, and the second infrared-light photodiode 24 generates second infrared light PD current I_ir2. At this time, current (second infrared light PD current I_ir2) generated by the second infrared-light photodiode 24, which mainly responds to infrared light, becomes larger than current (second visible light PD current I_v2) generated by the second visible-light photodiode 23, which mainly responds to visible light, in the second photoelectric conversion block 6 in the complementary current supply block 3.

Because of this, the generated second current Ia21 flows from the coupling node 14 toward the second photoelectric conversion block 6. In other words, the second current Ia21 is generated so as to flow out of the current mirror composed of the first and second transistors 11, 12. When the second current Ia21 is regarded as reference current, the second transistor 12 of the current mirror outputs current. In other words, the output current (complementary current Ia3) flows out from the second transistor 12.

In addition, in the third photoelectric conversion block 18, current (third infrared-light PD current I_ir3) generated by the third infrared-light photodiode 26, which mainly responds to infrared light becomes larger than current (third visible light PD current I_v3) generated by the third visible-light photodiode 25, which mainly responds to visible light. However, as described above, the third visible-light photodiode 25 and the third infrared-light photodiode 26 in the third photoelectric conversion block 18 of the photoelectric conversion device 1 according to the third embodiment are configured so as to establish an inequality when illuminated with black-body radiation at a color temperature of 2800 K or higher: third visible light PD current I_v3>third infrared-light PD current I_ir3. Because of this, the third photoelectric conversion block 18 generates the third current Ia31 that flows into the coupling node 32. In other words, the third current Ia31 is generated so as to flow toward the current mirror composed of the first and second transistors 27, 28. The current mirror of the complementary current generation circuit 19 does not output mirror current in response to the current flowing thereto. Because of this, the second transistor 28 does not output current.

Therefore, when receiving light from a light source that emits black-body radiation, such as sunlight, with a color temperature of 2800 K or higher, the current from the first photoelectric conversion block 2 and the current from the complementary current supply block 3 are combined (first current Ia1+complementary current Ia3) and the combined current is output from the output node 5.

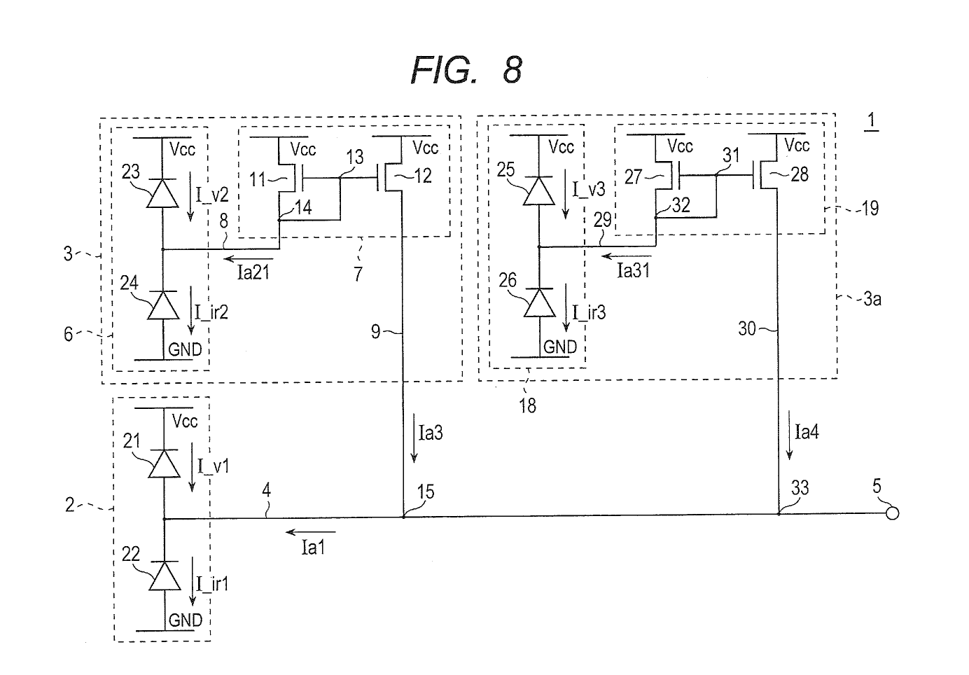

FIG. 8 is a circuit diagram illustrating exemplary operation of the photoelectric conversion device 1 when a light source, such as an incandescent lamp, emits light including a lot of infrared light. In this embodiment, the third visible-light photodiode 25 and third infrared-light photodiode 26 of the third photoelectric conversion block 18 are configured so as to establish an inequality when illuminated with black-body radiation at a color temperature of 2800 K or higher: third visible light PD current I_v3 third infrared-light PD current I_ir3. In addition, the third visible-light photodiode 25 and third infrared-light photodiode 26 are configured so as to establish an inequality when illuminated with black-body radiation at a color temperature of lower than 2800 K: third visible light PD current I_v3<third infrared-light PD current I_ir3.

Light including a lot of infrared light at a color temperature of 2800 K or lower from a light source, such as an incandescent lamp, causes the first infrared-light photodiode 22 to generate a larger amount of photocurrent (first infrared light PD current than the photocurrent (first visible light PD current I_v1) generated by the first visible-light photodiode 21. The first current Ia1 obtained from the difference between the first visible light PD current I_v1 and first infrared light PD current I_ir1 flows from the coupling node 15 toward the first photoelectric conversion block 2 (negative direction).

In the second photoelectric conversion block 6, current (second infrared light PD current I_ir2) generated by the second infrared-light photodiode 24, which mainly responds to infrared light, becomes larger than current (second visible light PD current I_v2) generated by the second visible-light photodiode 23. The second current Ia21 flows through the second wire 8 toward the second photoelectric conversion block 6. The second current Ia21 is larger in amount than second current Ia21 generated from sunlight. The current mirror of the complementary current generation circuit 7 receives the second current Ia21 as reference current. At this time, the output current (complementary current Ia3) from the current mirror's second transistor 12 increases in response to the second current Ia21.

As described above, the third visible-light photodiode 25 and third infrared-light photodiode 26 are configured so as to establish an inequality when illuminated with black-body radiation at a color temperature of lower than 2800 K: third visible light PD current I_v3<third infrared-light PD current I_ir3. The current (third infrared-light PD current I_ir3) generated by the third infrared-light photodiode 26, which mainly responds to infrared light, becomes larger than the current (third visible light PD current I_v3) generated by the third visible-light photodiode 25, which mainly responds to visible light. Because of this, the third current Ia31 obtained from the difference between the third visible light PD current I_v3 and third infrared-light PD current I_ir3 flows from the coupling node 32 toward the third photoelectric conversion block 18 through the third wire 29. In other words, the third current Ia31 is generated so as to flow out from the current mirror composed of the first and second transistors 27, 28.

The current mirror of the complementary current generation circuit 19 receives the third current Ia31 as reference current and generates output current (Ia4) corresponding to the third current Ia31. The complementary current Ia4 is output from the current mirror's second transistor 28 to be supplied to the coupling node 33 through the complementary current supply wire 30.

Consequently, when light including black-body radiation at a color temperature of lower than 2800 K is emitted from a light source, such as an incandescent lamp, currents generated by the first photoelectric conversion block 2, second photoelectric conversion block 6, and third photoelectric conversion block 18 are combined, and the combined current, first current Ia1+complementary current Ia3+complementary current Ia4, is output from the output node 5.

As described above, the areas of the visible-light photodiode and the infrared-light photodiode in the photoelectric conversion device 1 of the third embodiment are set so that the first current Ia1+complementary current Ia3+complementary current Ia4 flow in a positive direction (the current flows out from the output node 5). By automatically operating the second photoelectric conversion block 6 and third photoelectric conversion block 18 to appropriately deal with light sources, the photoelectric conversion device 1 can output a certain amount of current in relation to a certain illuminance irrespective of the types of light source.

In the third embodiment described above, the reference color temperature is set to 2800 K as a condition required for the third photoelectric conversion block 18 to operate; however, this condition does not limit the technical scope of the present invention. For instance, the color temperature for the third photoelectric conversion block 18 to operate can be changed to any degree by adjusting the light amount with a light-shielding structure (AL layer) that partially blocks the upper part of the photodiode from light.

Furthermore, the area of each photodiode is defined as follows: first visible-light photodiode 21=second visible-light photodiode 23+third visible-light photodiode 25; and first infrared-light photodiode 22=second infrared-light photodiode 24+third infrared-light photodiode 26. The areas of the visible-light photodiodes and infrared-light photodiodes are specified so as to establish an inequality: leakage current of visible-light photodiode<leakage current of infrared-light photodiode. Thus, even if the photodiode leakage current increases due to high temperature, the influences caused by the leakage current are canceled out, thereby obtaining correct photocurrent irrespective of temperature variations.

### Fourth Embodiment

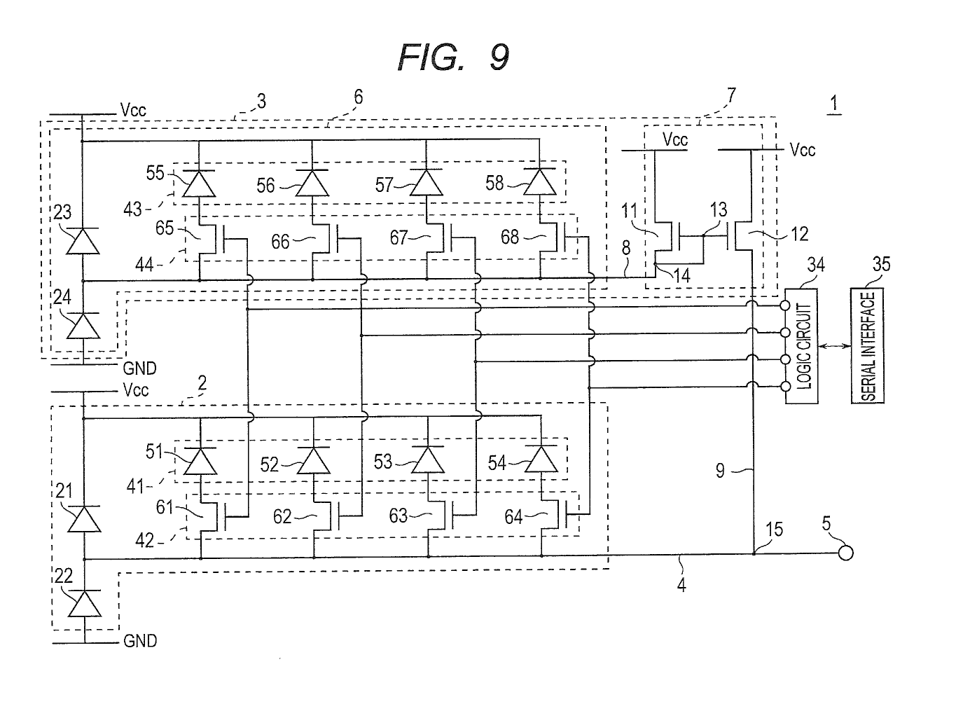

The fourth embodiment of the present invention will be described below. FIG. 9 is a circuit diagram illustrating an exemplary configuration of a photoelectric conversion device 1 according to the fourth embodiment. The photoelectric conversion device 1 of the fourth embodiment has a function of changing light-receiving area with a selection switch.

Referring to FIG. 9, the photoelectric conversion device 1 of the fourth embodiment includes a first photoelectric conversion block 2 and a complementary current supply block 3. The first photoelectric conversion block 2 includes a first adjustment photoelectric conversion unit 41 and a first switch unit 42. The complementary current supply block 3 includes a second photoelectric conversion block 6 having a second adjustment photoelectric conversion unit 43 and a second switch unit 44. In addition, the photoelectric conversion device 1 of the fourth embodiment includes a logic circuit 34 and serial interface 35.

As shown in FIG. 9, the first adjustment photoelectric conversion unit 41 includes a first adjustment photodiode 51, a second adjustment photodiode 52, a third adjustment photodiode 53, and a fourth adjustment photodiode 54. The first switch unit 42 includes a first control switch 61, a second control switch 62, a third control switch 63, and a fourth control switch 64.

The first adjustment photodiode 51, second adjustment photodiode 52, third adjustment photodiode 53, and fourth adjustment photodiode 54 have peak sensitivity in a visible wavelength range as with the case of the first visible-light photodiode 21. More specifically, the peak sensitivity is approximately 600 nm. The cathode of the first adjustment photodiode 51 is coupled with a first wire 4 via the first control switch 61. The cathode of the second adjustment photodiode 52 is coupled with the first wire 4 via the second control switch 62. The cathode of the third adjustment photodiode 53 is coupled with the first wire 4 via the third control switch 63. The cathode of the fourth adjustment photodiode 54 is coupled with the first wire 4 via the fourth control switch 64.

The second adjustment photoelectric conversion unit 43 includes a fifth adjustment photodiode 55, a sixth adjustment photodiode 56, a seventh adjustment photodiode 57, and an eighth adjustment photodiode 58. The second switch unit 44 includes a fifth control switch 65, a sixth control switch 66, a seventh control switch 67, and an eighth control switch 68.

The fifth adjustment photodiode 55, sixth adjustment photodiode 56, seventh adjustment photodiode 57, and eighth adjustment photodiode 58 have peak sensitivity in a visible wavelength range as with the case of the second visible-light photodiode 23. More specifically, the peak sensitivity is approximately 600 nm. The cathode of the fifth adjustment photodiode 55 is coupled with a second wire 8 via the fifth control switch 65. The cathode of the sixth adjustment photodiode 56 is coupled with the second wire 8 via the sixth control switch 66. The cathode of the seventh adjustment photodiode 57 is coupled with the second wire 8 via the seventh control switch 67. The cathode of the eighth adjustment photodiode 58 is coupled with the second wire 8 via the eighth control switch 68.

The gates of the first control switch 61 and fifth control switch 65 are coupled with each other and coupled with the logic circuit 34. In the same manner, the gates of the second control switch 62 and sixth control switch 66 are coupled with each other and coupled with the logic circuit 34.

The gates of the third control switch 63 and seventh control switch 67 are coupled with each other and coupled with the logic circuit 34. The gates of the fourth control switch 64 and eighth control switch 68 are coupled with each other and coupled with the logic circuit 34.

The first photoelectric conversion block 2 generates photocurrent (first current Ia1) with the visible-light photodiodes (first visible-light photodiode 21, and the first adjustment photodiode 51 to fourth adjustment photodiode 54) and the infrared-light photodiode (first infrared-light photodiode 22). The second photoelectric conversion block 6 generates photocurrent (second current Ia2) with the visible-light photodiodes (second visible-light photodiode 23, and the fifth adjustment photodiode 55 to eighth adjustment photodiode 58) and the infrared-light photodiode (second infrared-light photodiode 24).

The photoelectric conversion device 1 outputs photocurrent generated from ambient light by adding the photocurrent from the first photoelectric conversion block 2 and the photocurrent from the second photoelectric conversion block 6 (first current Ia1+second current Ia2). The output is supplied to an amplifier (not shown) in the latter stage. In the photoelectric conversion device 1 according to the fourth embodiment, respective element areas of the photodiodes are set as follows: first visible-light photodiode 21=second visible-light photodiode 23; first adjustment photodiode 51=fifth adjustment photodiode 55; second adjustment photodiode 52=sixth adjustment photodiode 56; third adjustment photodiode 53=seventh adjustment photodiode 57; fourth adjustment photodiode 54=eighth adjustment photodiode 58; and first infrared-light photodiode 22=second infrared-light photodiode 24. In addition, as with the case of the aforementioned embodiments, the sensitivity of the photodiodes is changed by partially blocking the open windows of the photodiodes from light with a light-shielding structure, such as an AL layer.

The logic circuit 34 controls couplings between the first wire 4 and any one of the first adjustment photodiode 51 to fourth adjustment photodiode 54. Likewise, the logic circuit 34 controls couplings between the second wire 8 and any one of the fifth adjustment photodiode 55 to eighth adjustment photodiode 58. When an external device of the photoelectric conversion device 1 is used to control the couplings, the external device transmits an instruction to turn ON or OFF the first to fourth control switches 61 to 64 to the logic circuit 34 via the serial interface 35. The logic circuit 34 outputs a control signal to a control terminal of the first to fourth control switches 61 to 64 in response to the instruction. Simultaneously, the fifth to eighth control switches 65 to 68 are set to be ON or OFF.

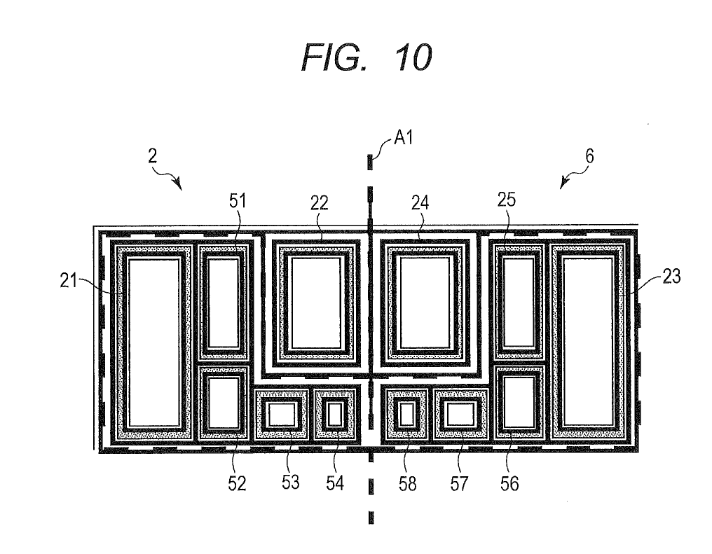

FIG. 10 is a plan view illustrating an exemplary configuration of the first photoelectric conversion block 2 and second photoelectric conversion block 6 according to the fourth embodiment. As shown in FIG. 10, the first photoelectric conversion block 2 and second photoelectric conversion block 6 of the fourth embodiment are symmetrically arranged with respect to axis A1. In addition, the first photoelectric conversion block 2 and second photoelectric conversion block 6 are arranged in the same layout.

Specifically, the first visible-light photodiode 21 and second visible-light photodiode 23 have the same element areas, while the first infrared-light photodiode 22 and the second infrared-light photodiode 24 have the same element areas. Furthermore, the first adjustment photodiode 51 and the fifth adjustment photodiode 55 have the same element areas. The second adjustment photodiode 52 and sixth adjustment photodiode 56 have the same element areas. The third adjustment photodiode 53 and the seventh adjustment photodiode 57 have the same element areas. The fourth adjustment photodiode 54 and the eighth adjustment photodiode 58 have the same element areas.

In the photoelectric conversion device 1 according to the fourth embodiment, the areas of the first visible-light photodiode 21 and the first to fourth adjustment photodiodes 51 to 54 are all different from one another. Therefore, 16 different photodiode element areas are selectable by combinations of switches. In addition, photodiodes of the same element size generate the same amount of dark current. By this law, provision of the photodiodes of the same size can cancel out the dark current in photocurrent. More specifically, the current difference between leakage current of the second visible-light photodiode 23 and second adjustment photoelectric conversion unit 43 and leakage current of the second infrared-light photodiode 24 is folded by the current mirror to be sign-inverted and works to cancel out the current difference between leakage current of the first visible-light photodiode 21 and the first adjustment photoelectric conversion unit 41 and leakage current of the first infrared-light photodiode 22. This cancellation eliminates the influences of the high-temperature leakage current and allows the photoelectric conversion device 1 to output constant current which is unaffected by temperature.

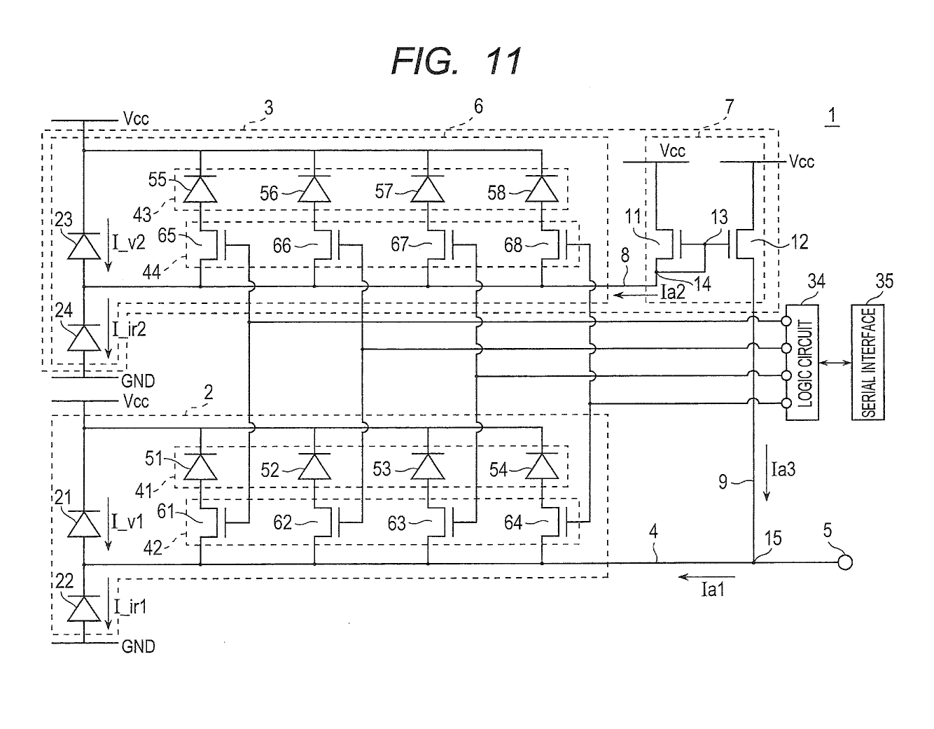

FIG. 11 is a circuit diagram illustrating exemplary operation of the photoelectric conversion device 1 according to the fourth embodiment. FIG. 11 illustrates the photoelectric conversion device 1 illuminated with light including a lot of infrared light. In the embodiment below, the first current Ia1, which is generated by the first photoelectric conversion block 2 and flows through the first wire 4, is expressed by: first current Ia1=first visible light PD current I_v1−first infrared light PD current I_ir1. In this description, combined current of the visible-light photodiodes (a first visible-light photodiode 21 and first to seventh adjustment photodiodes 51 to 57) in the first photoelectric conversion block 2 is referred to as first visible light PD current I_v1. The second current Ia2, which is generated by the second photoelectric conversion block 6 and flows through the second wire 8, is expressed by: second current Ia2=second visible light PD current I_v2−second infrared light PD current I_ir2.

In this description, combined current of the visible-light photodiodes (the second visible-light photodiode 23, and fifth to eighth adjustment photodiodes 55 to 58) in the second photoelectric conversion block 6 is referred to as second visible light PD current I_v2. When the photoelectric conversion device 1 is illuminated with light including a lot of infrared light and the first current Ia1 in the first photoelectric conversion block 2 becomes zero, the photoelectric conversion device 1 according to the fourth embodiment is configured to establish the relationship between the second visible light PD current I_v2, which is the combined current of the second photoelectric conversion block 6 and the second infrared light PD current I_ir2: second visible light PD current I_v2<second infrared light PD current I_ir2. Thus, the areas of the first visible-light photodiode 21, first to seventh adjustment photodiodes 51 to 57, and the first infrared-light photodiode 22 are set as described above.

In the complementary current supply block 3, second current Ia2 (second visible light PD current I_v2−second infrared light PD current I_ir2), which is generated from the light including a lot of infrared light, flows through the second wire 8 so as to be drawn into the second photoelectric conversion block 6. Therefore, the second current Ia2 is folded by a 1:1 current mirror and output as a complementary current Ia3. The complementary current Ia3 is expressed as: (second infrared light PD current I_ir2−second visible light PD current I_v2)=complementary current Ia3.

The complementary current Ia3 is added to the first current Ia1 from the first photoelectric conversion block 2. In addition, the photoelectric conversion device 1 of the fourth embodiment has the photodiodes whose light-receiving areas are set so as to establish an inequality: |first visible light PD current I_v1−first infrared light PD current I_ir1|<|second visible light PD current I_v2−second infrared light PD current I_ir2|, in other words, complementary current Ia3>first current Ia1. Accordingly, even if the output of the first photoelectric conversion block 2 is negative current (in a direction that the first current Ia1 (first visible light PD current I_v1−first infrared light PD current I_ir1) flowing through the first wire 4 is drawn toward the first photoelectric conversion block 2), the current output is always positive.

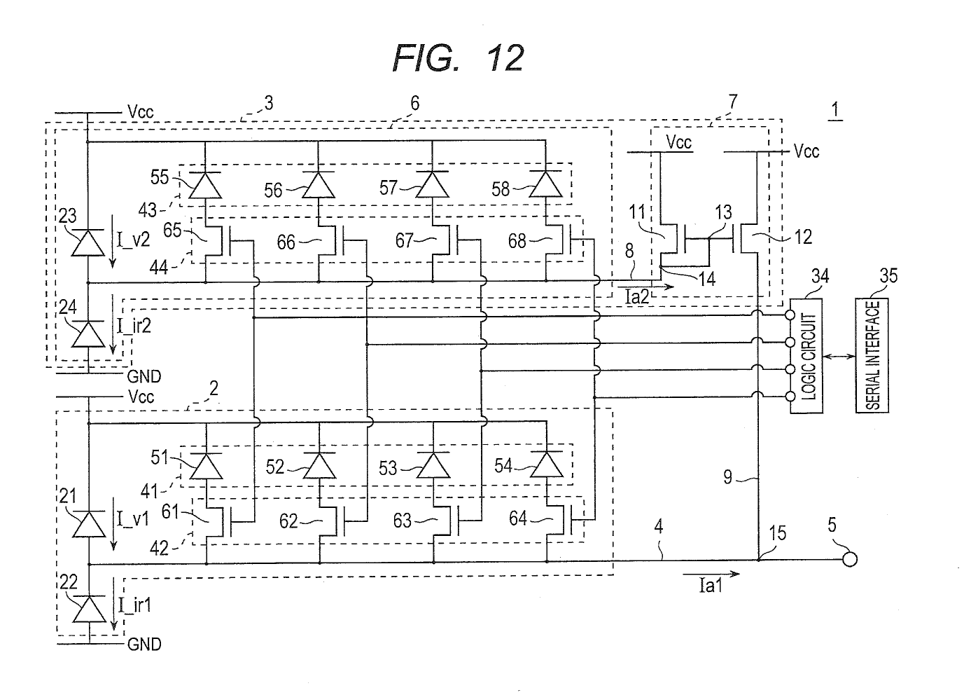

FIG. 12 is a circuit diagram illustrating another exemplary operation of the photoelectric conversion device 1 according to the fourth embodiment. FIG. 12 illustrates the operation of the photoelectric conversion device 1 that is illuminated with light including a lot of visible light. When light including a lot of visible light is emitted from a light source, such as a fluorescent lamp, the second photoelectric conversion block 6 generates second visible light PD current I_v2>second infrared light PD current I_ir2 from such light including a lot of visible light. Then, second current Ia2 from the second photoelectric conversion block 6 flows through the second wire 8 in the positive direction (direction in which the second current Ia2 is drawn out from the second photoelectric conversion block 6 to the complementary current generation circuit 7). The complementary current generation circuit 7, which is a PMOS current mirror, does not generate output current, i.e., generate zero current. Then, only the current, (first visible light PD current I_v1−first infrared light PD current I_ir1)=first current Ia1, from the first photoelectric conversion block 2 is output from the output node 5. The photoelectric conversion device 1 of the fourth embodiment that is configured as described above can output a certain amount of current in relation to a certain illuminance irrespective of the types of light source.

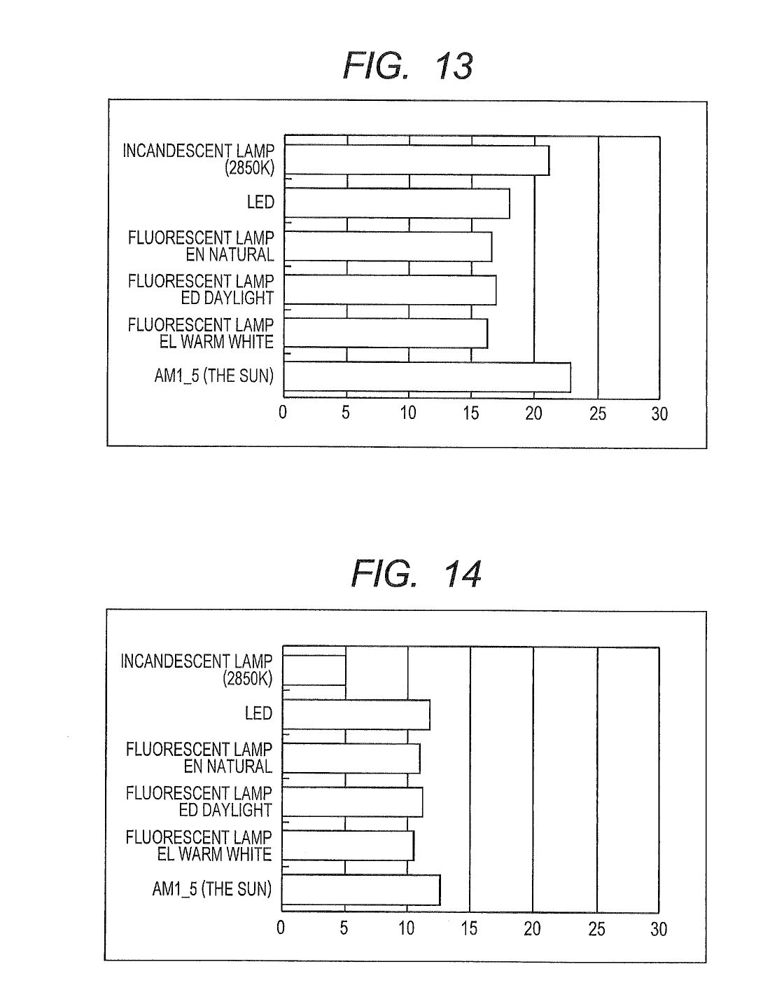

FIGS. 13 and 14 are graphs showing output current presented by light source with the first control switch 61 to eighth control switch 68 in different switching states. FIG. 13 shows output current presented by light source when all of the first to eighth control switches 61 to 68 are turned ON. FIG. 14 shows output current listed by light source when all the switches are turned OFF.

As described above, light emitted from an incandescent bulb (color temperature of 2850 K) includes a lot of infrared light. On the contrary, light emitted from a fluorescent lamp is mostly composed of visible light components. Because of the difference in light components, FIGS. 13 and 14 show that the output current generated with light emitted from the incandescent bulb significantly varies with the areas of the visible-light photodiodes and infrared-light photodiodes.

General illumination sensors receive light through an external panel of an apparatus in which the sensors are integrated. Recently, wide-spreading smartphones often employ a panel having spectral transmission characteristics that decrease visible light transmissivity and maintain infrared light transmissivity for the purpose of making the opening of the illumination sensor inconspicuous. Switching the first to eighth control switches 61 to 68 makes it possible to appropriately deal with such spectral transmission characteristics. In addition, switching the first to eighth control switches 61 to 68 is also effective in dealing with the panel characteristics that vary according to smartphone suppliers.

### Fifth Embodiment

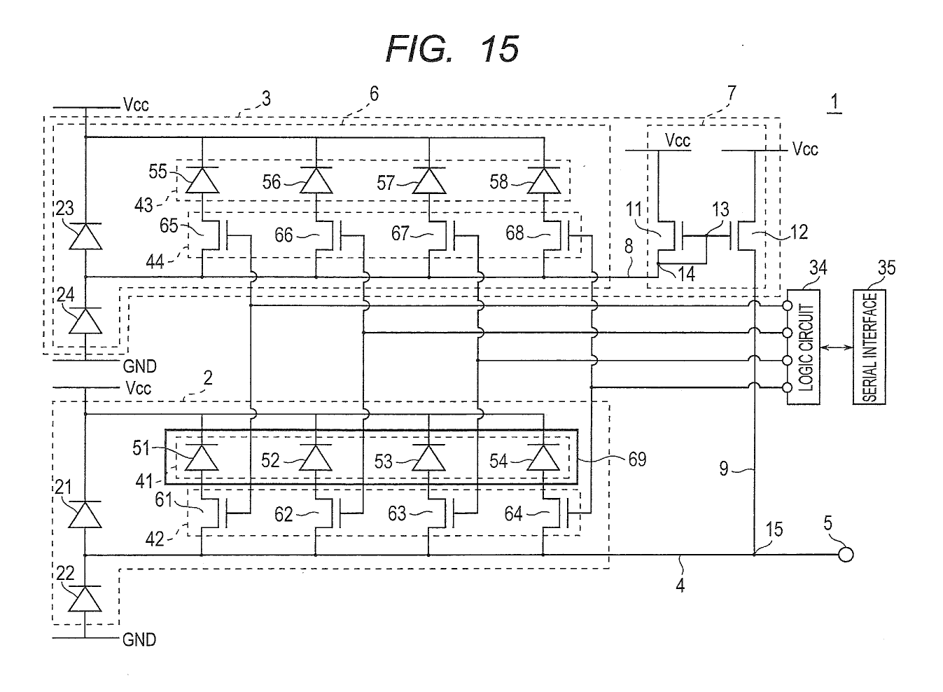

The fifth embodiment of the present invention will be described below. FIG. 15 is a circuit diagram illustrating an exemplary configuration of a photoelectric conversion device 1 according to the fifth embodiment. The photoelectric conversion device 1 of the fifth embodiment is similar to the photoelectric conversion device 1 of the fourth embodiment having a function of adjusting the light-receiving area by the switches, but further includes a light-shielding structure (AL layer) 69. The light-shielding structure (AL layer) 69 is provided over the first adjustment photoelectric conversion unit 41 to block light (light shielding) emitted to below the first adjustment photoelectric conversion unit 41. This arrangement of the light-shielding structure 69 permits only dark current to flow in the first adjustment photodiode 51 to fourth adjustment photodiode 54 of the fifth embodiment when being illuminated with light. Since the photodiodes of the same element size generate the same amount of dark current, adjusting the dark current generated by the blocked photodiodes of the same size can cancel out dark current in photocurrent on the light receiving side.

The photodiodes of the photoelectric conversion device 1 of the fifth embodiment have element areas as follows: first visible-light photodiode 21=second visible-light photodiode 23; first adjustment photodiode 51=fifth adjustment photodiode 55; second adjustment photodiode 52=sixth adjustment photodiode 56; third adjustment photodiode 53=seventh adjustment photodiode 57; fourth adjustment photodiode 54=eighth adjustment photodiode 58; and first infrared-light photodiode 22=second infrared-light photodiode 24. By setting the element areas as above, the first photoelectric conversion block 2 and second photoelectric conversion block 6 generate the same amount of leakage current, respectively, at high temperature and the leakage current of the first photoelectric conversion block 2 and the leakage current of the second photoelectric conversion block 6 are cancelled out to be zero. According to the photoelectric conversion device 1 of the fifth embodiment, only the area ratio between the visible-light photodiode and the infrared-light photodiode of the second photoelectric conversion block 6 can be changed by switching the first to eighth control switches 61 to 68, thereby freely changing the spectral characteristics.

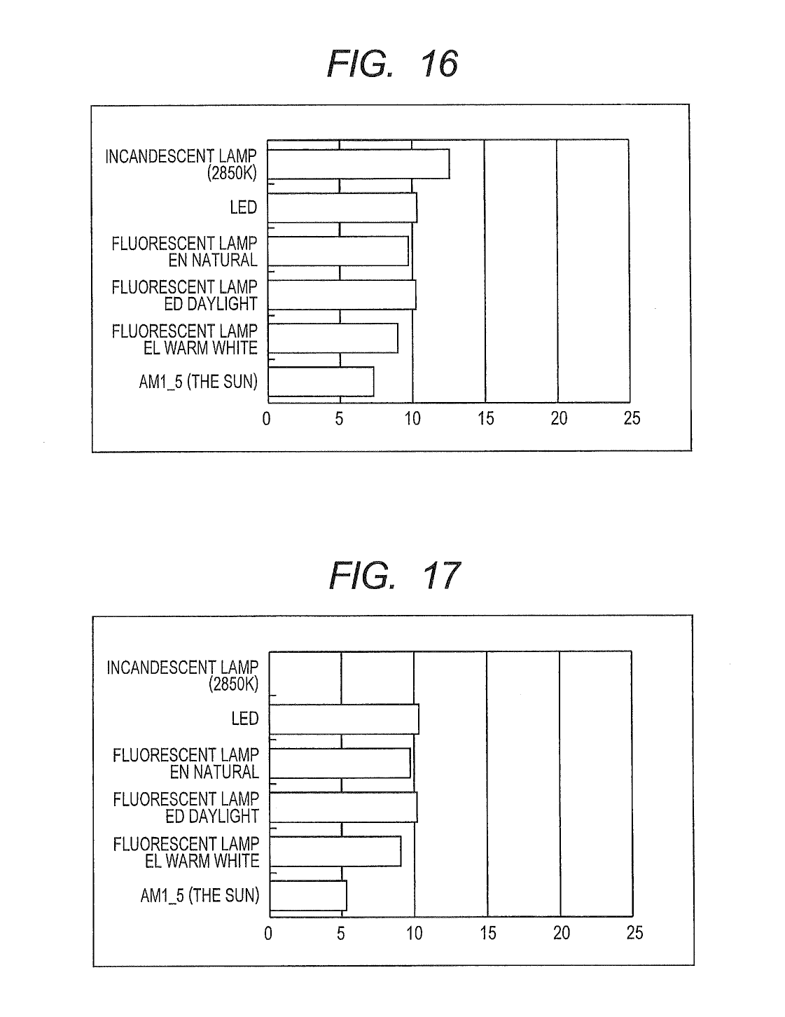

FIGS. 16 and 17 are graphs showing output current presented by light source with the first control switch 61 to eighth control switch 68, in different switching states, of the photoelectric conversion device 1 of the fifth embodiment. FIG. 16 shows output current presented by light source when all of the first to eighth control switches 61 to 68 are turned ON. FIG. 17 shows output current presented by light source when all the switches are turned OFF.

As described above, light emitted from an incandescent bulb (color temperature of 2850 K) includes a lot of infrared light. On the contrary, light emitted from a fluorescent lamp is mostly composed of visible light components. In comparison with the photoelectric conversion device 1 of the fourth embodiment, the photoelectric conversion device 1 of the fifth embodiment exhibits further significant variations in output current generated from light emitted from the incandescent bulb. Therefore, the photoelectric conversion device 1 can appropriately deal with light emitted from the incandescent bulb by switching the first to eighth control switches 61 to 68. In addition, the sensitivity of the photoelectric conversion device 1 of the fifth embodiment is less variable to the fluorescent lamp emitting a lot of visible light than the photoelectric conversion device 1 of the fourth embodiment. Therefore, the photoelectric conversion device 1 of the fifth embodiment is applicable to the case where changes in sensitivity to the fluorescent lamps, which emit a lot of visible light, are not desirable.

### Sixth Embodiment

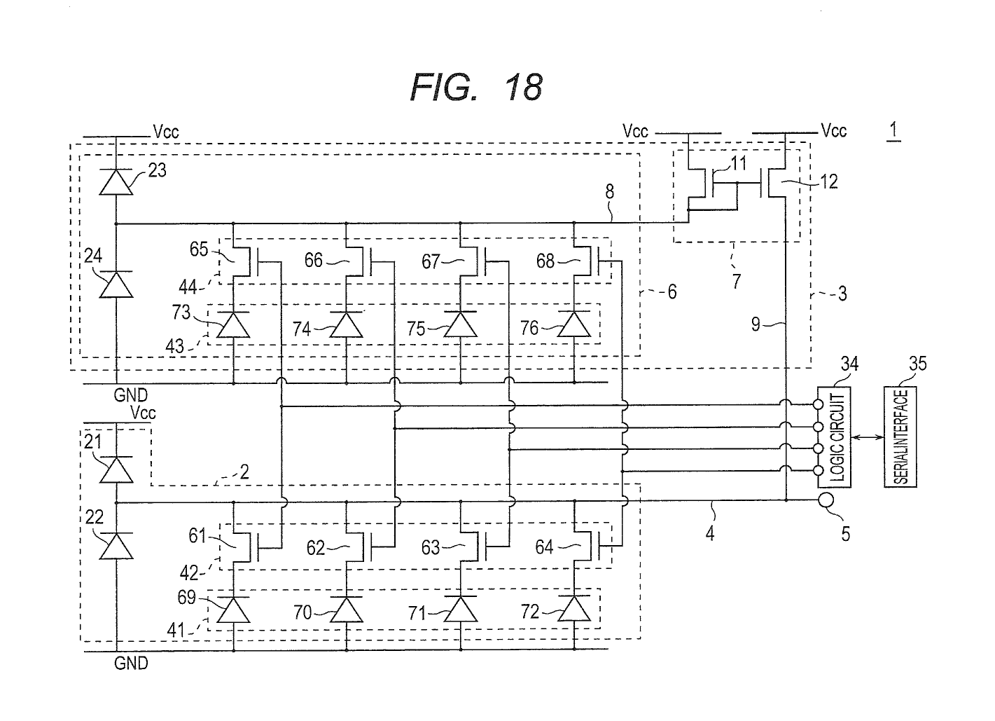

The sixth embodiment of the present invention will be described below. FIG. 18 is a circuit diagram illustrating an exemplary configuration of a photoelectric conversion device 1 according to the sixth embodiment. As illustrated in FIG. 18, the photoelectric conversion device 1 includes a plurality of infrared-light photodiodes (first adjustment photodiode (infrared) 69 to eighth adjustment photodiode (infrared) 76). In addition, a first control switch 61 to fourth control switch 64 are provided between the anodes of the first adjustment photodiode (infrared) 69 to fourth adjustment photodiode (infrared) 72 and a first wire 4. The first control switch 61 to fourth control switch 64 change the coupling between the anodes of the first adjustment photodiode (infrared) 69 to fourth adjustment photodiode (infrared) 72 and the first wire 4 in response to a control signal. Similarly, a fifth control switch 65 to eighth control switch 68 are provided between the anodes of the fifth adjustment photodiode (infrared) 73 to eighth adjustment photodiode (infrared) 76 and a second wire 8. The fifth control switch 65 to eighth control switch 68 change the coupling between the anodes of the fifth adjustment photodiode (infrared) 73 to eighth adjustment photodiode (infrared) 76 and the second wire 8 in response to a control signal.

### Seventh Embodiment

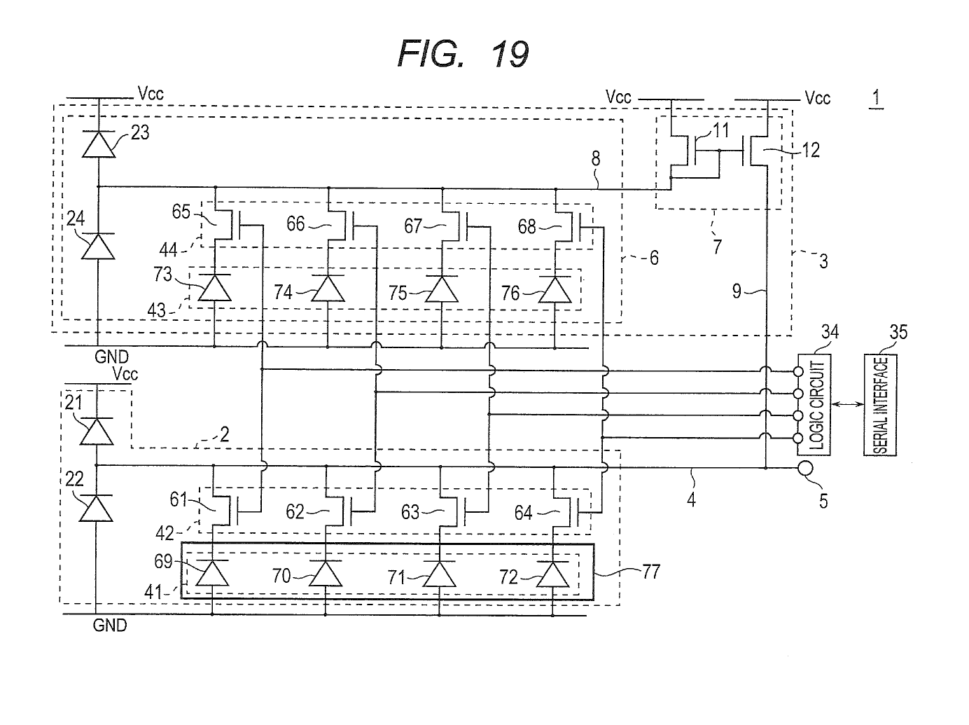

The seventh embodiment of the present invention will be described below. FIG. 19 is a circuit diagram illustrating an exemplary configuration of the photoelectric conversion device 1 according to the seventh embodiment. The photoelectric conversion device 1 of the seventh embodiment is similar to the photoelectric conversion device 1 of the sixth embodiment, but further includes a light-shielding structure (AL layer) 77. Referring to FIG. 19, the light-shielding structure (AL layer) 77 is provided over the first adjustment photoelectric conversion unit 41 to block light (light shielding) emitted to below the first adjustment photoelectric conversion unit 41. This arrangement of the light-shielding structure 77 permits only dark current to flow in the first adjustment photodiode (infrared) 69 to fourth adjustment photodiode (infrared) 72 of the seventh embodiment when illuminated with light.

In addition, the first photoelectric conversion block 2 and the second photoelectric conversion block 6 are configured so as to have the same amount of leakage current at high temperature. According to the photoelectric conversion device 1 of the seventh embodiment, only the area ratio between the visible-light photodiode and the infrared-light photodiode of the second photoelectric conversion block 6 can be changed by switching the first control switch 61 to eighth control switch 68, thereby freely changing the spectral characteristics as with the case of the photoelectric conversion device 1 of the fifth embodiment.

In the foregoing, the invention made by the inventors of the present invention has been concretely described based on the embodiments. However, the present invention is not limited to the foregoing embodiments and various modifications and alterations can be made within the scope of the present invention. Also, the above embodiments can be combined in the range in which any confliction or contradiction does not occur in their configurations and operations.

What is claimed is:

1. A photoelectric conversion device comprising:
a first photoelectric conversion block that generates a first carrier in response to light emitted thereon;
a first wire that is coupled with the first photoelectric conversion block and through which first current generated with the first carrier flows;
a complementary current supply block that generates complementary current to complement the first current; and
an output node that outputs current obtained by combining the first current and the complementary current,
wherein the complementary current supply block includes:
a second photoelectric conversion block that has the same element area as that of the first photoelectric conversion block and generates a second carrier in response to the light emitted thereon;
a second wire that is coupled with the second photoelectric conversion block and through which second current generated with the second carrier flows; and
a complementary current generation circuit that is coupled with the second wire and generates the complementary current based on the second current,
wherein the first wire is coupled with the output node and the first photoelectric conversion block,
wherein the second wire is coupled with the complementary current generation circuit and the second photoelectric conversion block, and
wherein the complementary current generation circuit generates the complementary current based on a direction in which the second current flows through the second wire and supplies the generated complementary current to the first wire.

2. The photoelectric conversion device according to claim 1,
wherein the second photoelectric conversion block has the same layout as the first photoelectric conversion block.

3. The photoelectric conversion device according to claim 2,
wherein when the second current flows into the second photoelectric conversion block, the complementary current generation circuit generates the complementary current to flow to the first wire in response to the second current.

4. The photoelectric conversion device according to claim 3,
wherein the complementary current generation circuit includes a current mirror circuit,
wherein the current mirror circuit includes a first transistor and a second transistor having a gate (base) commonly coupled with a gate (base) of the first transistor, and
wherein when the second current flowing from the first transistor to the second photoelectric conversion block is defined as reference current, the second transistor generates output current corresponding to the reference current and supplies the output current serving as the complementary current to the first wire.

5. The photoelectric conversion device according to claim 4,
wherein when the second current flows from the second photoelectric conversion block to the first transistor, the complementary current generation circuit stops supplying the complementary current in response to the second current.

6. The photoelectric conversion device according to claim 5,
wherein the first photoelectric conversion block includes:
a first photoelectric conversion element with a peak wavelength at a first wavelength of the light; and
a second photoelectric conversion element that is coupled with the first photoelectric conversion element and has a peak wavelength at a second wavelength, which is different from the first wavelength, of the light,
wherein the second photoelectric conversion block includes:
a third photoelectric conversion element with a peak wavelength at the first wavelength; and
a fourth photoelectric conversion element that is coupled with the third photoelectric conversion element and has a peak wavelength at the second wavelength, and
wherein when the first photoelectric conversion element has a first illuminated area that receives the light, the second photoelectric conversion element has a second illuminated area that receives the light, the third photoelectric conversion element has a third illuminated area that receives the light, and the fourth photoelectric conversion element has a fourth illuminated area that receives the light, a ratio between the first illuminated area and the second illuminated area is equal to or higher than a ratio between the third illuminated area and the fourth illuminated area.

7. The photoelectric conversion device according to claim 6,
wherein the first photoelectric conversion element and the second photoelectric conversion element have the peak wavelengths in a visible wavelength range of the light, and
wherein the third photoelectric conversion element and the fourth photoelectric conversion element have the peak wavelengths in an infrared wavelength range of the light.

8. The photoelectric conversion device according to claim 6 further comprising:
another complementary current supply block that generates another complementary current to complement the first current,
wherein the other complementary current supply block includes:
a third photoelectric conversion block that generates a third carrier in response to the light;
a third wire that is coupled with the third photoelectric conversion block and through which third current generated with the third carrier flows; and
another complementary current generation circuit that is coupled with the third wire and generates the complementary current based on the third current.

9. The photoelectric conversion device according to claim 8,
wherein the other complementary current supply block includes:
a fifth photoelectric conversion element with a peak wavelength at the first wavelength; and
a sixth photoelectric conversion element that is coupled with the fifth photoelectric conversion element and has a peak wavelength at the second wavelength, and
wherein when the fifth photoelectric conversion element has a fifth illuminated area that receives the light and the sixth photoelectric conversion element has a sixth illuminated area that receives the light, a ratio of the first illuminated area to the second illuminated area is equal to or higher than a ratio of the third illuminated area to the fourth illuminated area, and a ratio of the third illuminated area to the fourth illuminated area is equal to or higher than a ratio of the fifth illuminated area to the sixth illuminated area.

10. The photoelectric conversion device according to claim 6,
wherein the first photoelectric conversion block further includes:
a first adjustment photoelectric conversion unit that is coupled with the first photoelectric conversion element in parallel; and
a first switch that is disposed between the first adjustment photoelectric conversion unit and the first wire to interrupt the coupling between the first adjustment photoelectric conversion unit and the first wire in response to a control signal,
wherein the second photoelectric conversion block includes:
a second adjustment photoelectric conversion unit that is coupled with the third photoelectric conversion element in parallel; and
a second switch that is disposed between the second adjustment photoelectric conversion unit and the second wire to interrupt the coupling between the second adjustment photoelectric conversion unit and the second wire in response to the control signal,
wherein the first adjustment photoelectric conversion unit includes a plurality of first adjustment photoelectric conversion elements that have a peak wavelength at the first wavelength and have different light-receiving areas from one another,
wherein the second adjustment photoelectric conversion unit includes a plurality of second adjustment photoelectric conversion elements that have a peak wavelength at the first wavelength and have different light-receiving areas from one another,
wherein the areas of the second adjustment photoelectric conversion elements correspond to the areas of the first adjustment photoelectric conversion elements, one by one, respectively,
wherein the first switch interrupts the coupling between the first wire and any one of the first adjustment photoelectric conversion elements in response to a control signal, and
wherein the second switch interrupts the coupling between the second wire and a second adjustment photoelectric conversion element that is arranged in the same layout as the interrupted first adjustment photoelectric conversion element in response to the control signal.

11. The photoelectric conversion device according to claim 10,
wherein the first switch includes a plurality of control switches on the first photoelectric conversion block side, the control switches being coupled one-to-one with the first adjustment photoelectric conversion elements to individually control the coupling between the respective first adjustment photoelectric conversion elements and the first wire, and
wherein the second switch includes a plurality of control switches on the second photoelectric conversion block side, the control switches being coupled one-to-one with the second adjustment photoelectric conversion elements to individually control the coupling between the respective second adjustment photoelectric conversion elements and the second wire.

12. The photoelectric conversion device according to claim 10 further comprising a light-shielding structure that is disposed over the first adjustment photoelectric conversion unit to block the light emitted to the first adjustment photoelectric conversion unit.

13. The photoelectric conversion device according to claim 10,
wherein when the sum of the light-receiving areas of the first photoelectric conversion element and the first adjustment photoelectric conversion unit is a first total area, the light-receiving area of the second photoelectric conversion element is a second illuminated area, the sum of the light-receiving areas of the third photoelectric conversion element and the second adjustment photoelectric conversion unit is a second total area, and the light-receiving area of the fourth photoelectric conversion element is a fourth illuminated area, a ratio between the first total area and the second illuminated area is equal to or higher than a ratio between the second total area and the fourth illuminated area.
